(19) United States
(12) Patent Application Publication
(10) Pub. No.: US 2005/0216833 A1
(43) Pub. Date: Sep. 29, 2005

(54) Printing data processor, printing system, method of object incorporation into page data, and program

(75) Inventor: Kazuhiro Inoue, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/079,172

(22) Filed: Mar. 15, 2005

(30) Foreign Application Priority Data
Mar. 25, 2004 (JP) JP2004-089650
Oct. 25, 2004 (JP) JP2004-309261

(51) Int. Cl. G06F 17/00

(52) U.S. Cl. 715/517; 715/513

(57) ABSTRACT

In the placement of an object as a page element into page data, when an object should be set with the necessity of placement or format defined according for example to the placement condition of another object on a page, this object is associated with such another object to be provided with setting such as the necessity of placement. The placement condition of the associated object depends on the setting of the source object of association. Thus the change of the setting of the source object of association realizes change of the placement condition of the target object. Alternatively, a meta title indicating the description of each page is defined and the necessity of placement of an object is associated with this meta title, thereby realizing object placement associated with the description of page text.

### BACKGROUND OF THE INVENTION

1. Field of the Invention

The present invention relates to a printing data processor responsible for the placement of objects as page elements into page data.

2. Description of the Background Art

In preparing a printed matter with a large number of pages (which is a so-called page printing), it is quite customary to print page numbers (nombre) or heads such as book title, chapter title or the like as page elements on the periphery of a text area, to print a caption indicating the description of each page on a front edge, or to print information for printing management on a region to be trimmed in a later step. The placement and the contents of a printed output of such nombre or head are generally decided to comply with the layout of a substantial (text) portion of a printed matter on the side responsible for layout (on the input side). In this case, nombre and heads are usually placed in one of layout processes using a known software. Further, nombre-specific pagination technique realizing a high degree of efficiency in pagination is also known, an exemplary technique of which is introduced in Japanese Patent Application Laid-Open No. 11-191100 (1999).

In many cases, several types of page elements including the foregoing heads are used in one printed matter. It is also a practice frequently followed that a page on which a page element should be placed is decided depending on the description of each page or on a page on which another page element is placed. Alternatively, making reference to these sources of dependence, the format and description of a page element may be decided. In these cases, any change in a reference such as description of a page or a page on which another element is placed forces some alteration of a page element having been placed on the basis of such references.

Such alteration may be required with high possibility in a stage after a manuscript has been once received by an output side and a first proof is obtained, in which case the manuscript should principally be corrected by an input side responsible for layout to be available again for output operation. Further, a process film and a press plate when used by the output side should be formed again. These impair cost reduction and efficient use of time, resulting in reduced throughput. Additionally, such retrace of a workflow should be inherently avoided as much as possible.

According to a workflow using a so-called digital printer as an output device in which a printed matter is directly formed from data of an original received in the form of digital data, no process film or press plate is required. Thus the change of the placement and description of a page element on the output side, without returning once the data of an original to the side responsible for layout, leads to suppression of the foregoing throughput reduction.

However, even the workflow using such a digital printer has necessitated change of page elements on a one-by-one basis, thereby still causing an increasing operational burden of an operator on the output side with high possibility of errors.

According to the technique taught in Japanese Patent Application Laid-Open No. 11-191100 (1999), nombre already paginated is deleted to be replaced by new nombre. However, this technique fails to include the alteration of a nombre necessitated by the change of another nombre already paginated. Further, this technique is not intended to enhance efficiency in the change of nombre and the like necessitated by the change of the description of a page.

### SUMMARY OF THE INVENTION

The present invention relates to a printing data processor in which objects are incorporated into page data to additionally place page elements into a printed matter. According to the present invention, the printing data processor comprises: a placement condition information setting element for setting placement condition information applied for the placement of a page element into a printed matter, the placement condition information being in one-to-one correspondence to at least one form of object representing the page element; and a page data creation element for incorporating the at least one form of object into first page data based on the placement condition information to create second page data, the second page data representing a printed matter in which the page element is placed. The placement condition information setting element is capable of defining setting for incorporating the at least one form of object into each page of the first page data as the placement condition information. The setting can be associated with the contents of the each page.

When some object is to be additionally placed as a page element into page data, a condition required for the placement of this object on each page is associated with the contents of each page. In the placement of an object with description defined in response to the page contents, by establishing association in advance between this object and the page contents, it is not required to manually effect change required in this object necessitated by the change of the source of association. Thus a high degree of efficiency and reliability of processing is realized.

Preferably, when several forms of objects are incorporated to create the second page data, the placement condition information setting element is capable of setting placement condition information for incorporating one form of the several forms of objects into the each page in association with placement condition information on a different form of the several forms of objects.

When some object is to be additionally placed as a page element into page data, a condition required for the placement of this object on each page is associated with the placement condition of a different object to be placed on each page. In the placement of an object with placement setting defined according to placement setting of a different object, by establishing association in advance between this object and such a different object as a source of association, it is not required to manually effect change required in this object necessitated by the change of the source object of association. Thus a high degree of efficiency and reliability of processing is realized.

According to another aspect of the present invention, the placement condition information setting element is preferably capable of defining setting for incorporating the at least one form of object into each page of the first page data as the placement condition information, and the setting can be associated with the description of text of the each page.

When some object is to be additionally placed as a page element into page data, a condition required for the placement of this object on each page is associated with the description of page text. In the placement of an object suitably indicative of the description of page text, an object failing to reflect the change of the description of page text is prevented from remaining without manually checking up on the existence thereof. Thus object placement can be realized with a high degree of efficiency and reliability.

Accordingly, it is an object of the present invention to provide a printing data processor capable of changing a page element with a high degree of efficiency according to the change of the description of a source page or a page locating a source page element the placement of the page element depends on.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows the configuration of a printing system comprising a printing data processor according to a first preferred embodiment of the present invention;

FIG. 2 explains functions realized in a controller of the printing data processor;

FIGS. 3 and 4 each show an input dialog presented on a display part by the action of a placement condition information setting part;

FIGS. 5A and 5B each show how “heads” as page elements are placed according to predetermined setting in the image of a page printing represented by certain page data DP;

FIGS. 6A and 6B each show chief settings for placement of “heads” into page data;

FIGS. 7 through 10 each show part of the contents of page data described in a PDL;

FIG. 11 shows a representative flow of object placement and object renewal in the printing data processor;

FIG. 12 shows how “heads” as page elements are placed according to predetermined setting in the image of a page printing represented by certain page data;

FIG. 13 shows chief settings for placement of “heads” into page data;

FIGS. 14 and 15 each show part of the contents of page data described in a PDL;

FIG. 16 shows part of page data reflecting change made to the description on page 2;

FIG. 17 shows the image of a printed matter represented by the page data of FIG. 16;

FIG. 18 shows part of page data reflecting change made to the description on page 2;

FIG. 19 shows the image of a printed matter represented by the page data of FIG. 18;

FIG. 20 shows part of page data reflecting change made to the description on page 2; and

FIG. 21 shows the image of a printed matter represented by the page data of FIG. 20.

### DESCRIPTION OF THE PREFERRED EMBODIMENTS

### First Preferred Embodiment

<System Outline>

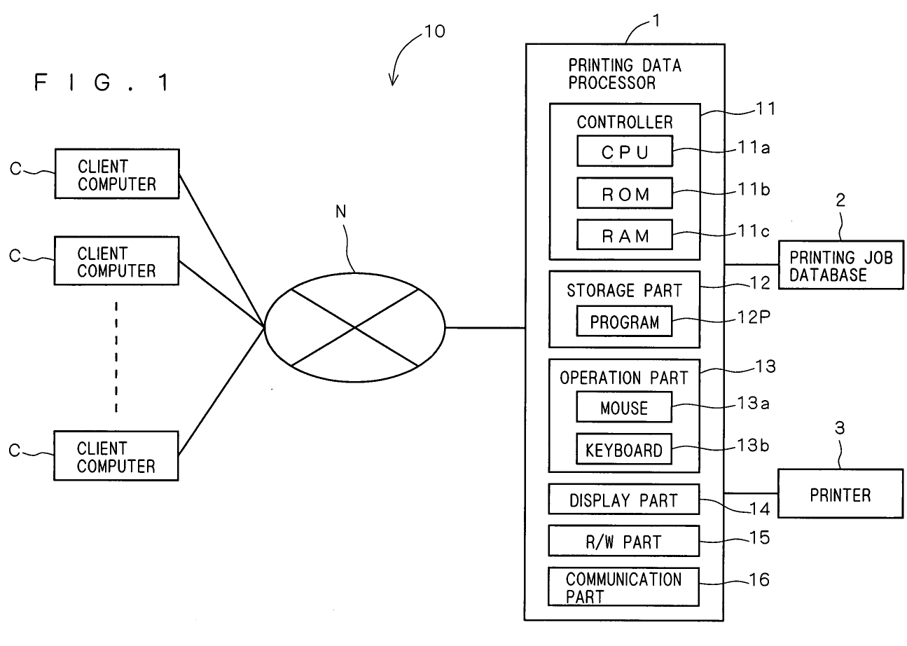

FIG. 1 schematically shows the configuration of a printing system 10 comprising a printing data processor 1 according to a first preferred embodiment of the present invention. The printing system 10 serves to produce a printed output from page data formed by using certain layout software preferably on the basis of a predetermined PDL (page description language) such as PDF (portable document format). In addition to the printing data processor 1, the printing system 10 mainly comprises a printing job database 2, a printer 3 and client computers C. The printing data processor 1 is electrically connected to the printing job database 2 and to the printer 3. the printing data processor 1 is connected through a network N to the client computers C.

The printing data processor 1 is realized by a so-called server computer. In response to a printing instruction from the client computer C, the printing data processor 1 receives page data as a target of printing and an instruction to set printing conditions, based on which printing job data DJ is created. That is, the printing job data DJ contains the page data as a target of printing, and process conditions (such as rasterizing condition) for realizing an output suitable for the output characteristics of the printer 3. The printing data processor 1 controls the printer 3 based on the printing job data DJ thus created to produce a certain printed output. The printing data processor 1 also serves to incorporate page elements into the page data as a target of printing. The configuration of the printing data processor 1 will be discussed later.

The printing job database 2 is responsible for storage and accumulation of the printing job data DJ (including DJ1 through DJn) created in the printing data processor 1.

The printer 3 serves to produce a printed output according to the printing job data created in the printing data processor 1. That is, the printer 3 is a so-called digital printer capable of producing a printed output based on printing job data received in the form of digital data.

The client computers C are general-purpose personal computers. The client computers C each function as creation means to be responsible for layout of a printed output to be produced and creation of page data described in a predetermined page description language by reading and executing certain layout software not shown. The client computers C also function as instruction means to provide printing instructions to the printer 3 to produce an output based on page data. The number of the client computers C is not limited to three as shown in FIG. 1.

<Printing Data Processor>

With reference to FIG. 1, the printing data processor 1 mainly comprises: a controller 11 including a CPU 11a, a ROM 11b and a RAM 11c and realizing various functions discussed later; a storage part 12 storing several pieces of data and programs; an operation part 13 including a mouse 13a, a keyboard 13b and the like for allowing an operator to give various types of instructions; a display part 14 which may be a display device; an R/W part 15 responsible for reading and writing of data to and from various types of portable recording media such as an MO, CD-R, DVD-RAM and the like; and a communication part 16 as an interface responsible for data transfer to and from another device and the like.

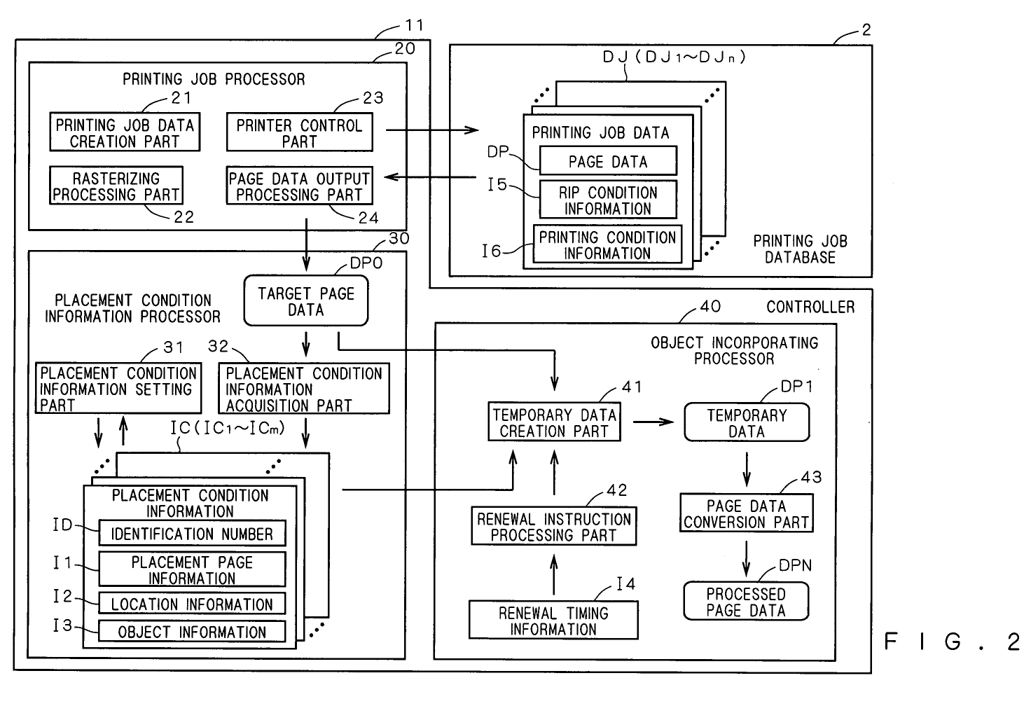

FIG. 2 explains functions realized by the controller 11 in the printing data processor 1. In the controller 11, execution of a certain program 12P (FIG. 1) stored in the storage part 12 realizes mainly a printing job processor 20, a placement condition information processor 30 and an object incorporating processor 40 by the action of the CPU 11a, ROM 11b an RAM 11c. FIG. 2 also shows the data flow in the placement condition information processor 30 and in the object incorporating processor 40 when in operation.

In the printing data processor 1, while presenting the contents of page data to be processed or various types of setting menus on the display part 14, a so-called GUI (graphical user interface) is realized by the functions of the controller 11, operation part 13, display part 14 and the like that allows an operator to provide an executive instruction by clicking for example a certain menu button or by drag-and-drop of an icon and the like using the mouse 13a to perform certain processing. Each component of the controller 11 also becomes operative to perform its function using the GUI.

The printing job processor 20 is responsible mainly for creation of printing job data based on an instruction from the client computer C, for causing the printer 3 to execute printing and the like. The printing job processor 20 mainly comprises a printing job data creation part 21, a rasterizing processing part 22, a printer control part 23 and a page data output processing part 24.

In response to an instruction to execute printing of certain page data DP given from the client computer C, the printing job data creation part 21 creates printing job data DJ corresponding to this page data DP. In the first preferred embodiment, when the page data DP created by the client computer C is to be subjected to printing, the client computer C concurrently sets up conditions for rasterization and printing based on predetermined setting menus, and transfers the conditions thus defined as RIP condition information I5 and printing condition information I6 to the printing data processor 1. By the action of the printing job data creation part 21, the printing data processor 1 associates the page data DP with the RIP condition information I5 and printing condition information I6 to create the printing job data DJ. The RIP condition information I5 is indicative of process conditions for rasterization in the rasterizing processing part 22. The printing condition information I6 is indicative of printing conditions of the page data DP when printed by the printer 3 including the number of prints, sheet size, output resolution, printing density, scaling and the like.

When the printing job data DJ is created, the printing data processor 1 performs rasterization on the corresponding page data DP according to the description of the printing job data DJ. Thereafter the printing data processor 1 transfers the page data DP after rasterization to the printer 3 and controls the printer 3 according to the printing condition information I6, thereby producing a printed output.

The created printing job data DJ are accumulated in the printing job database 2. Then the accumulated printing job data DJ can be read through the client computer C to reproduce a printed output based on the read printing job data DJ.

The rasterizing processing part 22 is responsible for rasterization of the page data DP as a target of printing to convert the page data DP to raster data processible in the printer 3. Here, known techniques are applicable for rasterization.

The printer control part 23 controls the operations of the printer 3. When an instruction to execute printing based on certain printing job data DJ is sent from the client computer C, the printer control part 23 makes reference to the printing condition information I6 contained in this printing job data DJ, and, based on the description of the printing condition information I6, causes the printer 3 to execute printing of page data already rasterized, thereby producing a printed output.

The page data output processing part 24 serves to output the page data DP once merged into the printing job data DJ in another data file. As an example, such output is performed when the page data DP is subjected to object placement discussed below, in which case the page data DP is extracted from the printing job data DJ. The page data DP after being subjected to object placement is available again for creation of the printing job data DJ at the printing job data creation part 21.

The placement condition information processor 30 serves to set placement conditions required, in the case where objects as page elements such as nombre, heads, captions and the like are to be added to (incorporated into) page data once defined as a target of creation of printing job data, for incorporation of these objects. The placement condition information processor 30 mainly comprises a placement condition information setting part 31 and a placement condition information acquisition part 32.

The placement condition information setting part 31 serves to set several process conditions (placement conditions) required for incorporating an object into the page data DP to create placement condition information IC. The placement condition information IC is created in one-to-one correspondence to each object to be incorporated into a single piece of page data DP. The placement condition information IC (IC1 through ICm) includes an identification number ID, placement page information I1, location information I2 and an object information I3. The identification number ID uniquely identifies the placement condition information including IC1 through ICm, or an object designated by the corresponding placement condition information. The placement page information I1 is indicative of a page onto which an object is to be placed. The location information I2 is indicative of a position to which an object is to be located on a given page. The object information I3 is indicative of the description of an object to be incorporated. In creation of the placement condition information IC to be referenced for object placement, an operator uses a predetermined input dialog discussed below presented on the display part 14 by the action of the placement condition information setting part 31 to suitably perform input or selection, thereby defining necessary items.

The placement condition information acquisition part 32 serves to obtain the placement condition information IC about some object already placed in the page data DP to be subjected to object incorporation (target page data DP0) from the target page data DP0. Then the placement condition information setting part 31 is allowed to renew the placement condition information on the object once placed. At the time when the target page data DP0 is given, all the objects included in the page data DP0 may be subjected to automatic acquisition of placement condition information. As an alternative example, while presenting an arbitrary page on the display part 14, an object placed on this page is selected by the mouse 13a to obtain the placement condition information IC on this object.

The object incorporating processor 40 is responsible for object placement according to the placement condition information. The object incorporating processor 40 is also responsible for renewal process necessitated by the change of the sources in the case where this object has been placed making reference to a different page element or the description of a page. The object incorporating processor 40 mainly comprises a temporary data creation part 41, a renewal instruction processing part 42 and a page data conversion part 43.

The temporary data creation part 41 serves to create temporary data DP1 which temporarily realizes the result of object incorporation into the target page data DP0. The creation of the temporary data DP1 corresponds to a process of virtually placing an object set with placement condition information into the target page data DP0. The temporary data DP1 is capable of presenting such virtual placement on the display part 14. The temporary data DP1 shows the latest layout until a renewal instruction discussed below is given at predetermined time. The placement condition information processor 30 principally handles page data stored in the RAM 11c, and hence the temporary data DP1 is described not in a PDL but in the form suitably processible in the RAM 11c.

The renewal instruction processing part 42 serves to give an instruction to the temporary data creation part 41 to renew the temporary data DP1 according to renewal timing previously determined in renewal timing information I4. As an example, such renewal timing may be described in the renewal timing information I4 in such a way that an operator can renewal the temporary data DP1 by clicking a certain renewal button on a screen not shown. In this case, the renewal instruction processing part 42 gives a certain renewal instruction signal to the temporary data creation part 41 in response to an operator's click. On receipt of the renewal instruction signal, the temporary data creation part 41 becomes operative for example to relocate an object or change its description based on the placement condition information IC as of the receipt of the renewal instruction signal, thereby renewing the temporary data DP1.

The page data conversion part 43 serves to convert the temporary data DP1 at the time to page data described in a certain PDL in response to a certain instruction from an operator. The page data thereby obtained will especially be referred to as processed page data DPN.

<Condition Setting for Object Layout>

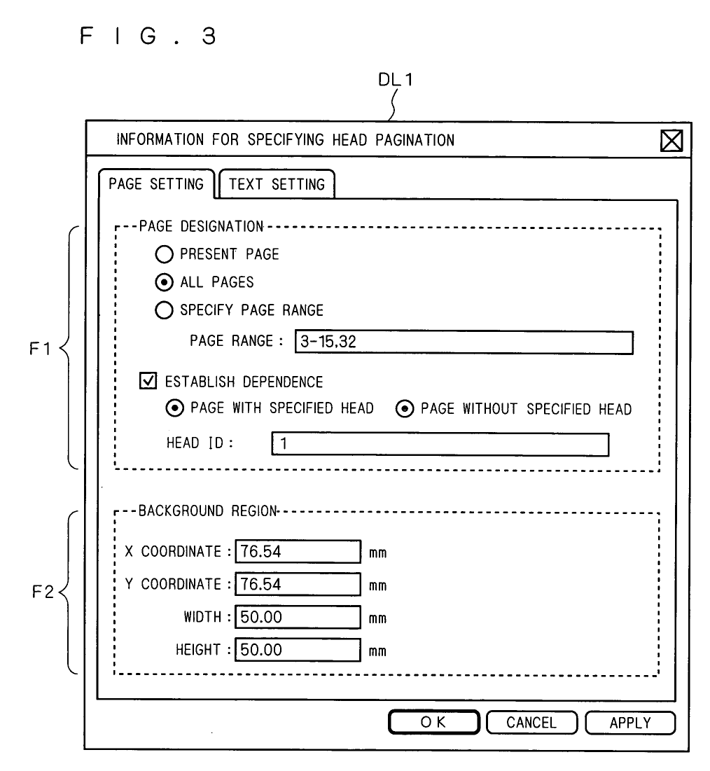

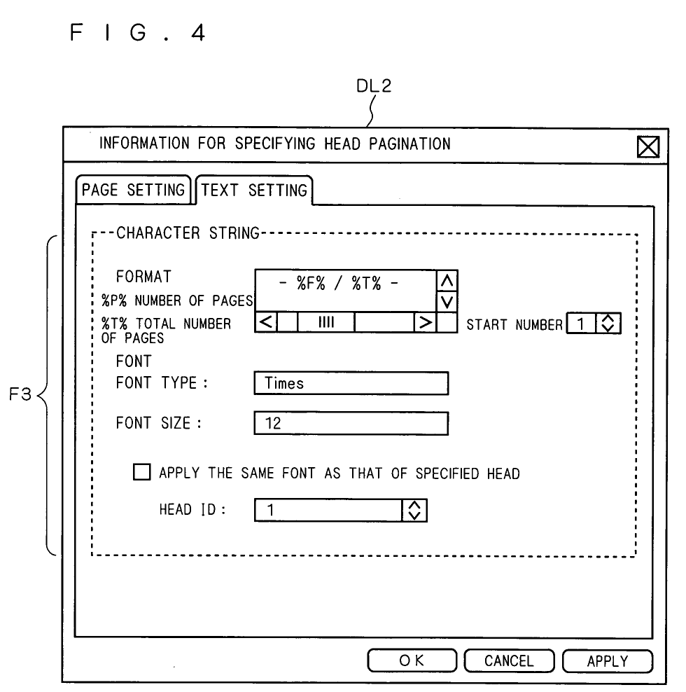

As discussed above, in creation of the placement condition information IC to be referenced for object placement, an operator uses a predetermined input dialog presented on the display part 14 by the action of the placement condition information setting part 31 to suitably perform input or selection, thereby defining necessary items. FIGS. 3 and 4 are exemplary input dialogs presented on the display part 14 by the action of the placement condition information setting part 31. In FIGS. 3 and 4, only a “head” as one of page elements is shown to be a target of processing. Alternatively, other page elements may be processed in a similar manner.

An input dialog DL1 shown in FIG. 3 includes a page designation field F1 and a location setting field F2. The page designation field F1 is applied to designation of a page intended for object placement. When an object as one of other page elements has already been placed on one page, the page designation field F1 is also applied to determination whether or not an object should be placed in association with (or depending on) the placement of such a previously placed object. The location setting field F2 is intended to set a position to which an object to be located. Each object is subjected to setting operations at the page designation and location setting fields F1 and F2, and the settings obtained therefrom form the placement page information I1 and the location information I2.

In the case of associating the placement of an object with the placement of another object, the identification number ID of such another object is specified in the page designation field F1.

An input dialog DL2 shown in FIG. 4 mainly includes a format setting field F3 for setting for example the format of an object to be placed. The description form and font of a head, for example, are set at the format setting field F3. When an object as one of other page elements has already been placed, the font of this object may be directly applied. In the case of associating the font setting of an object with that of another object (to establish dependence of the font setting on that of a different object), the identification number ID of such another object is specified in the font setting field F3.

The input dialogs DL1 and DL2 are switched using a tab.

<Placement and Association of Objects>

As discussed, for placement of an object as a page element into page data in the printing data processor 1 of the first preferred embodiment, association is established between a target object of placement required to be set with the necessity of placement or format according to the placement setting of another object placed on a page and such another object. Next, such association will be discussed.

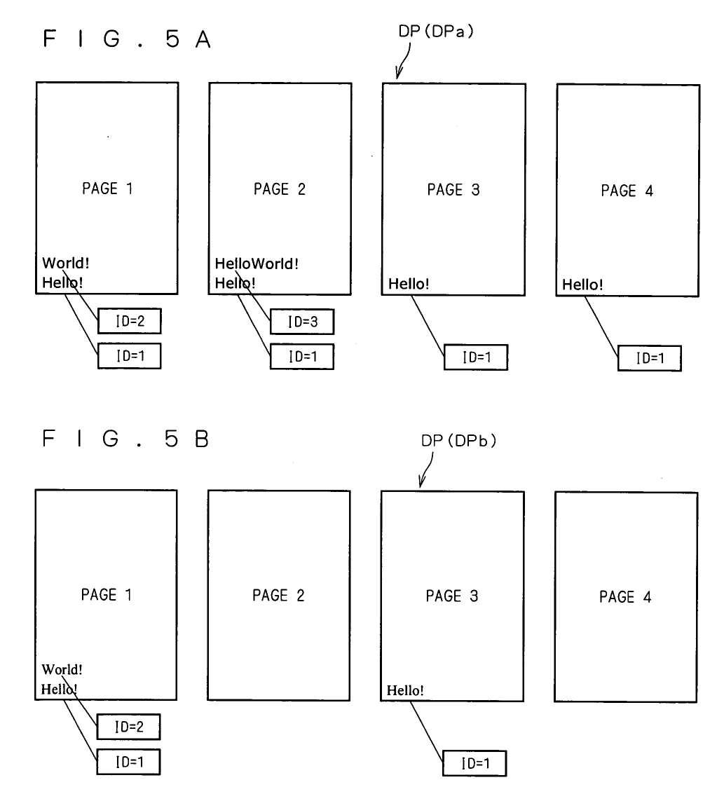

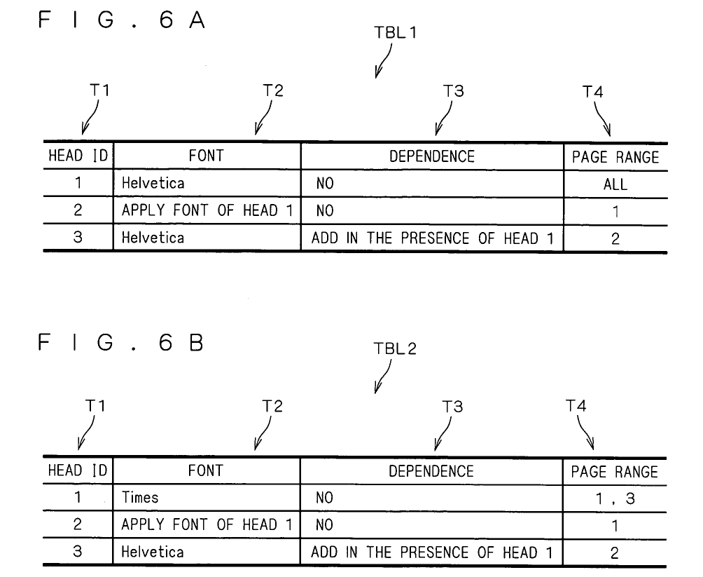

FIGS. 5A and 5B each show how “heads” as page elements are placed according to predetermined setting in the image of a page printing represented by certain page data DP. FIGS. 6A and 6B respectively show tables TBL1 and TBL2 in which chief settings for placement of “heads” placed in respective page data DP shown in FIGS. 5A and 5B are summarized. That is, the tables TBL1 and TBL2 each show part of the placement condition information IC of objects defined by an operator using the input dialogs DL1 and DL2. In the tables TBL1 and TBL2, an item T1 specifies identification numbers ID (heads IDs), an item T2 specifies fonts, an item T3 specifies dependence on an object identified by a different identification number ID, and an item T4 specifies the range of pages into which objects are to be placed as heads.

In page data DPa shown in FIGS. 5A and 6A, three objects assigned identification numbers ID “1”, “2” and “3” are placed as “head 1”, “head 2” and “head 3”, respectively. The object assigned the identification number ID “1” with the description “Hello!” is placed on all pages in a font “Helvetica”.

The object assigned the identification number ID “2” with the description “World!” is set with “the font of the head 1” in the item T2 for font specification. This means for setting the placement condition information on the object with the identification number ID “2”, settings defined in the format setting field F3 of the input dialog DL2 include that the font to be used is determined depending on the object assigned the identification number ID “1” which is namely the “head 1”. As discussed, the object assigned the identification number ID “1” is set with the font “Helvetica”. Thus the object with the identification number ID “2” is placed on page 1 within the page range specified in the item T4, in the same font which is “Helvetica”. If the font of the object with the identification number ID “1” is changed at some point in time, the font of the object with the identification number ID “2” is also changed to the same font at the time when a certain renewal instruction is given.

In the item T3 specifying dependence on a different object, the object assigned the identification number ID “3” with the description “HelloWorld!” is defined “to be incorporated in the presence of the head 1”. This means for setting the placement condition information on the object with the identification number ID “3”, settings defined in the page designation field F1 of the input dialog DL1 include that this object is to be placed in the presence of a specified head on a specified page, and that the specified object is the “head 1”. As seen from the item T4, the object with the identification number ID “3” is set to be placed only on page 2. Then the “head 3” is placed on page 2 according to the presence of the “head 1” on the same page. In the examples of FIGS. 5A and 6A, the “head 1” is set to be placed on all pages, and the “head 3” is also placed on page 2 accordingly. If the page rage for locating the “head 1” is changed at some point in time to remove page 2 from the rage for locating the “head 1”, the object corresponding to the “head 3” is set not to be placed on page 2 when a certain renewal instruction is given.

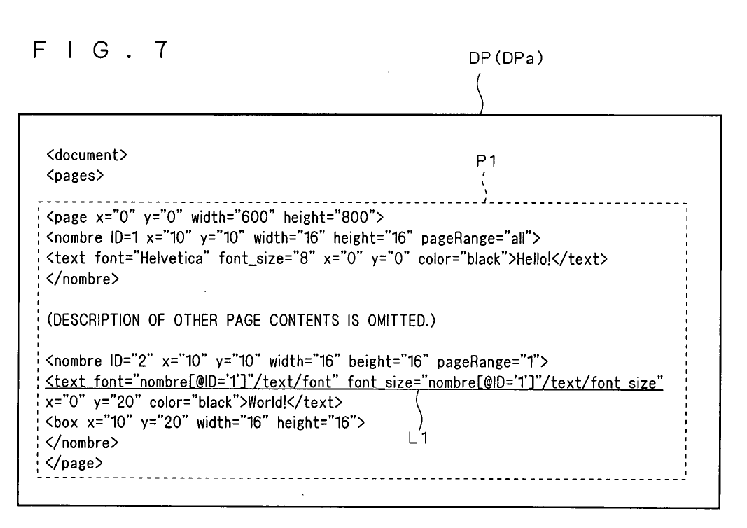

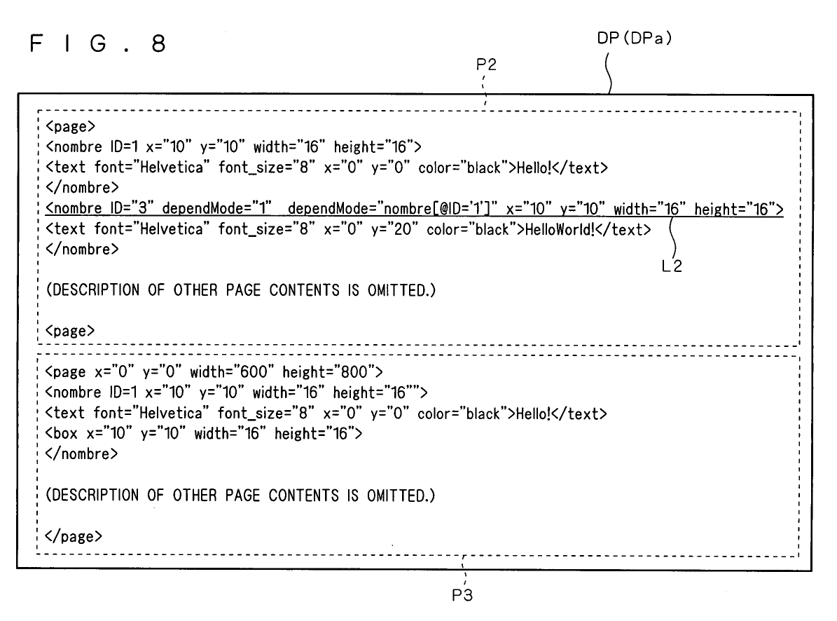

FIGS. 7 and 8 are views each showing part of the contents of the page data DPa after being subjected to object placement and conversion to be described in a PDL by the action of the page data conversion part 43. By the action of the page data conversion part 43, pages constituting the page data DP are defined by <page> tags. FIG. 7 shows page description P1 representing page 1. FIG. 8 shows page descriptions P2 and P3 respectively representing pages 2 and 3. Objects are defined by <nombre> tags.

In the page description P1 representing page 1, contents corresponding to the “head 1” and “head 2” are described in the portions between respective <nombre> and </nombre> tags. These heads are differentiated from each other by ‘ID’ attributes in the respective <nombre> tags. As seen from statement L1 of FIG. 7, regarding the “head 2” identified as ‘ID=2’, a <text> tag defining the description in detail specifies ‘nombre[@ID=‘1’]/text/font’ and ‘nombre[@ID=‘1’]/text/font_size’ as ‘font’ and ‘font_size’ attributes, respectively. Such description shows the association with the font of the head “1”.

As seen from statement L2 of FIG. 8, regarding the “head 3” identified as ‘ID=3’, description contained in a <nombre> tag of ‘dependMode=“nombre[@ID=‘1’]”’ as a ‘depend’ attribute expresses that the placement of the head 3 is associated with that of the “head 1”. There is also a description ‘dependMode=‘1’’ as a ‘dependMode’ attribute, showing that the “head 1” is placed on the same page as that locating the “head 3”. In case of absence of the “head 1”, a description ‘dependMode=‘0’’ will be made.

<Object Update>

The objects placed in the manner discussed above are subjected to change of the necessity of placement or change of the description as needed. When placement conditions of one object are changed and a certain renewal instruction is given to reflect such change, the first preferred embodiment characteristically realizes renewal of an object set with dependence on or association with the object after being subjected to change of placement conditions, as well as renewal of the object after being subjected to change of placement conditions. Next, object renewal process will be discussed using the page data DPa shown in FIGS. 5A and 6A as a target of renewal.

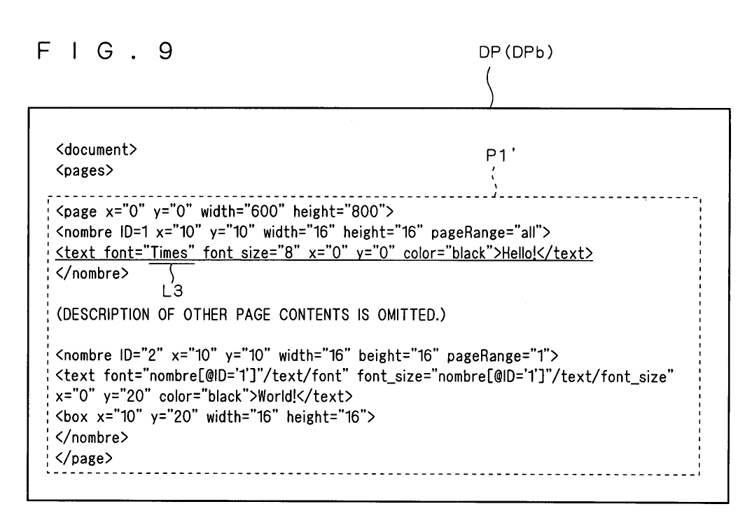

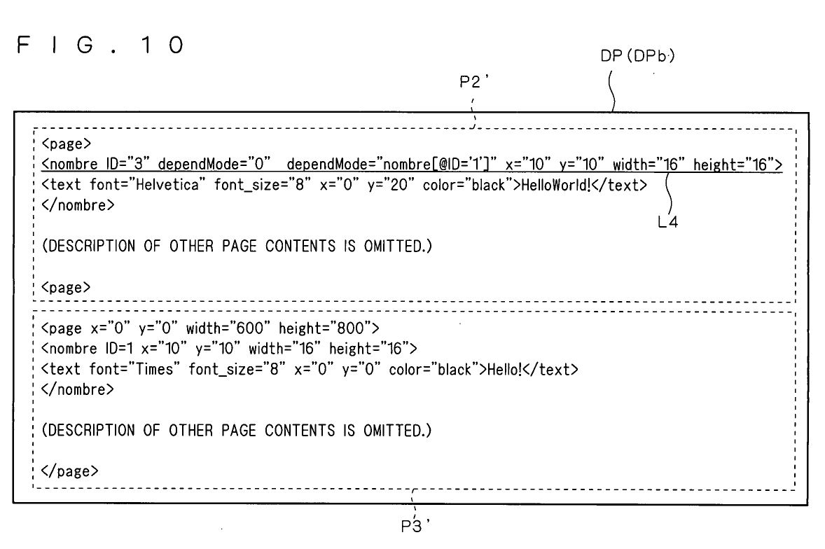

It is assumed page data DPb is the result of renewal process of the page data DPa. FIG. 5B shows how “heads” as page elements are placed in the page data DPb according to predetermined settings. The table TBL2 of FIG. 6B shows part of the placement condition information IC about the placement of “heads” placed in the page data DPb. FIGS. 9 and 10 are views each showing part of the contents of the data DPb created after being subjected to change of process conditions and conversion to be descried in a PDL by the action of the page data conversion part 43. FIG. 9 shows page description P1′ representing page 1. FIG. 10 shows page descriptions P2′ and P3′ respectively representing pages 2 and 3.

The settings in the table TBL2 reflecting changes to the settings in the table TBL1 contain two modifications. First, regarding the “head 1”, the font specified in the item T2 is changed from “Helvetica” to “Times”. Second, the page range specified in the item T4 is changed from “all pages” to “pages 1 and 3”. Namely, there is no change related to the “head 2” and “head 3”.

With such changes in the placement condition information IC about the “head 1”, a certain renewal instruction is given, whereby on the image of a printed matter represented by the page data DPb, the “head 1” appears only on pages 1 and 3 in a font “Times”. That is, with reference to FIGS. 9 and 10, the “head 1” identified as ‘ID=1’ is set with “Times” as a ‘font’ attribute as seen from part of statement L3 related to the “head 1” indicated by a doubled line. Further, as pages 2 and 4 will not locate the “head 1”, a <nombre> tag related to ‘ID=1’ realizing the “head 1” is omitted from the page description P2′ representing page 2 as seen from FIG. 10.

The “head 2” and “head 3” are subjected to no change in the placement condition information IC. Like in the placement of the page data DPa, the “head 2” is thus placed on page 1 applying “the font of the head 1”, in correspondence to which each statement in a <nombre> tag related to ‘ID=2’ is exactly the same as in the page data DPa. However, the font of the “head 1” is changed to “Times” in the page data DPb as discussed. The font setting of the “head 2” depends on the font of the “head 1”, and hence the “head 2” will be placed in a font “Times” after a renewal instruction is given.

There is no change in the dependence related to the “head 3” which specifies the “head 3” is “to be incorporated in the presence of the head 1”. Thus it is determined whether or not the “head 3” is to be placed. The page range for locating the “head 1” is changed to cover pages 1 and 3 as discussed, and hence the “head 1” will not be placed on page 2 as a target page of locating the “head 3”. The “head 3” will not appear accordingly as an image in the page data DPb as the results of process condition changes, in correspondence to which a <nombre> tag related to ‘ID=1’ realizing the “head 1” is omitted as discussed from the page description P2′ representing page 2 as seen from FIG. 10. Further, statement L4 in a <nombre> tag related to the “head 3” contains description ‘dependMode=0’ as a ‘dependMode’ attribute.

As discussed, by establishing association in advance between objects, change of placement conditions and the like of a source object of association allows a different object to be efficiently subjected to change without any particular process.

<Object Placement and Object Renewal>

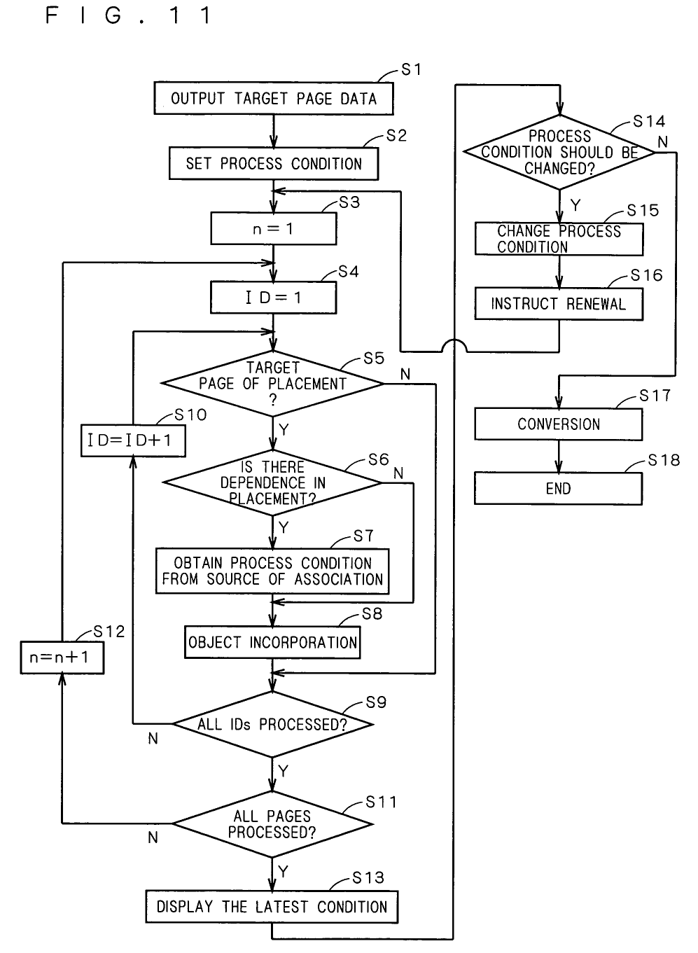

Next, the process in the first preferred embodiment for placement and renewal of an object as a page element will be discussed. FIG. 11 shows a representative flow of object placement and object renewal in the printing data processor 1.

First, by the action of the page data output processing part 24, page data to be processed is obtained as the target page data DP0 from certain printing job data DJ (step S1). Page data before being merged into the printing job data DJ may be a target of processing, in which case this page data is directly used as the target page data DP0.

Next, each object to be placed is subjected to setting operation of placement conditions required for object placement (step S2). As discussed, for setting placement conditions, several input dialogs presented on the display part 14 by the action of the placement condition information setting part 31 are used. An operator performs certain operation through the operation part 13, whereby each form of object to be placed is set with corresponding placement condition information IC including an identification number ID identifying an object, placement page information I1, location information I2 and object information I3. As an alternative setting operation of the location of an object, while presenting the image of an arbitrary page from the target page data DP0 on the display part 14, an object to be incorporated may be subjected to drag-and-drop to suitably set its location. When the page data DP0 in which some object has already been placed is the target page data of processing, the placement condition information acquisition part 32 obtains the placement condition information IC at this time related to this object from the page data DP0. Further, definition of the placement condition information IC may be such that the necessity of placement of one object depends on the placement of a different object, or that association is established to apply the same format to one object as that applied to a different object, as discussed.

When the target page data DP0 is obtained and the placement condition information IC is defined, the first page and subsequent pages are sequentially subjected to virtual object incorporation by the action of the temporary data creation part 41 based on the placement condition information set for each page (step S3). In object incorporation into one page, an object with the identification number ID “1” and those with subsequent identification numbers ID are sequentially subjected to incorporation (step S4).

If the n-th page is a target page of locating an object with some identification number ID, the temporary data creation part 41 first makes reference to the placement page information I1 to decide whether or not this object is set to be placed on the n-th page (step S5).

If the n-th page is specified as a target page (if the result at step S5 is YES), with reference to the placement page information I1 and object information I3 of the target object, it is determined whether the necessity of the placement of this object has dependence on the presence of another object, and whether this object is set with a format in association with the format of a different object (step S6).

If such dependence or association is established (if the result at step S6 is YES), information required for placement is obtained from the placement condition information IC about the source object of dependence or association (step S7). Thereafter the target object is incorporated (step S8). If there is no such dependence or association (if the result at step S6 is NO), the target object is incorporated according to the corresponding placement condition information IC (step S8). Here, incorporation means a state in which the information indicative of the target object is incorporated into the temporary data DP1 that allows page data locating objects to be presented on the display part 14.

Thereafter the presence or absence of a different object to be subjected to processing is determined (step S9). If there exists an object with a different identification number (if the result at step S9 is NO), the flow proceeds to step S10 where an object with a subsequent identification number ID is subjected to the same processing.

When objects with all the identification numbers ID have been subjected to processing (if the result at step S9 is YES), it is determined whether another page is to be subjected to processing (step S11). If there exists another page to be processed (if the result at step S11 is NO), the flow proceeds to step S12 where a subsequent page is subjected to the same processing.

The temporary data DP1 is completed when all pages have been subjected to processing (if the result at step S11 is YES), in response to which the image of a printed matter represented by the temporary data DP1 as the latest page data at that time is presented on the display part 14 (step S13).

If an operator does not request change of object placement or addition of an object at step S13, that is, if it is determined that there will be no change to be made at this time to the placement condition information indicative of a placed object (if the result at step S14 is NO), the page data conversion part 43 converts the temporary data DP1 to create the processed page data DPN described in a PDL (step S17). In creation of the processed page data DPN, the target page data DP0 may be overwritten or alternatively, separate data may be created. Once the processed page data DPN is created, the process flow ends (step S18).

If an operator requests change of the placement or contents of an object, or addition of a different object, that is, if the operator requests placement condition change (if the result at step S14 is YES), the operator gives a certain instruction through the operation part 13. Then by the action of the placement condition information setting part 31, several input dialogs as discussed above again appear on the display part 14. The operator performs certain operation through the operation part 13 to change the setting related to a predetermined object or set the placement conditions related to a new object (step S15).

On the occurrence of placement condition change, the temporary data DP1 should be renewed so that the temporary data DP1 can reflect the details of change. Accordingly, an instruction to effect such renewal should be given to the temporary data creation part 41 (step S16). A renewal instruction is timed to be given by the renewal instruction processing part 42 to coincide with the renewal timing specified in the renewal timing information I4. The renewal timing information I4 is set with conditions specifying for example that renewal should be effected when an operator clicks a certain renewal button on a screen not shown. Alternatively, renewal process may be effected at certain intervals regardless of the presence or absence of change in placement condition information IC.

When the renewal instruction processing part 42 gives a renewal instruction, the temporary data creation part 41 again follows the flow from step S3 through step S11 based on the placement condition information IC after renewal. The resultant temporary data DP1 is applied to present the image of a printed matter after changes have been effected on the display part 14. The operator again decides whether additional change should be made or processing should be completed, namely, whether page data should be written in a PDL.

As discussed, for additional placement of an object as a page element into page data in the printing data processor 1 of the first preferred embodiment, association is established between a target object required to be set with the necessity of placement or format according for example to the placement setting of another object on a page and such another object. The associated object is set with placement conditions depending on the setting of the source object of association. Thus the change of setting of the source object can cause change of the placement conditions of the associated object. Then, for placement of a target object required to be changed as a result of change in setting of another object as a page element, such change of each target object does not require manual operation, thereby realizing a high degree of efficiency and reliability of processing. Especially in a printing workflow of the printing data processor 1 employing a digital printer for use in output operation, an operational burden of an operator on the output side can be considerably lightened.

### Modifications of First Preferred Embodiment

In the first preferred embodiment described above, another is used as a source object of association in setting the placement conditions of a target object. Alternatively, a suitable selection dialog may be used to make reference to the description of page text. As an example, when wording described in a specific part of page text is to be applied as one of page elements such as heads, change of the part in the page text as a source of association easily effects necessitated change of a page element.

In the first preferred embodiment, a target of placement is in the form of text. An image may alternatively be applied as a target of placement or source of association.

### Second Preferred Embodiment

<Outline>

In setting the placement conditions of an object in a printing data processor, the placement conditions of an object may be defined in association with the description (or description theme) of the text of each page, instead of the content of specific wording or head of each page text. A second preferred embodiment of the present invention is intended for such setting. In a printing system comprising a printing data processor of the second preferred embodiment, each constituent element is operative in the same manner as that of a corresponding element in the printing system of the first preferred embodiment. Hence elements will be designated by the same reference numerals and will not be described.

Like in the first preferred embodiment, target page data is also transferred from the printing job processor 20 to the placement condition information processor 30. Then by the action of the placement condition information processor 30, an operator gives an instruction using a predetermined input dialog not shown to set the placement condition information IC on an object. According to the description of the placement condition information IC, the object is additionally placed into the target page data to obtain new page data.

<Contents of Placement Condition Information>

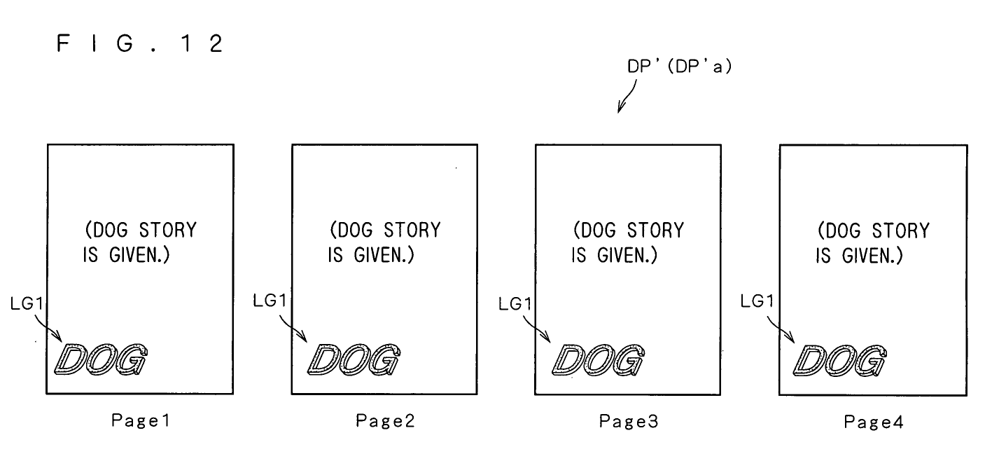

FIG. 12 shows how “heads” as page elements are placed according to predetermined settings in the image of a page printing represented by certain page data DP′ (DP′a). As discussed below, in the second preferred embodiment, a logo object LG1 (as one of image objects) is placed as a “head”.

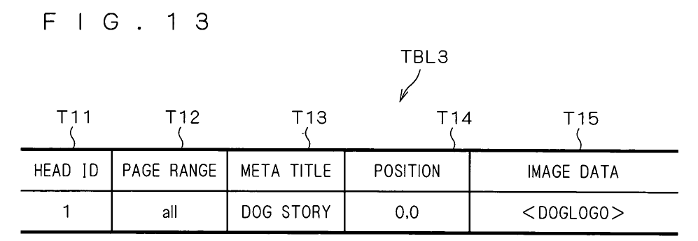

FIG. 13 shows a table TBL3 in which chief settings for placement of the “head” placed in the page data DP′ a of FIG. 12 are summarized. That is, the table TBL3 shows part of the placement condition information IC on the logo object LG1 defined by an operator. The operator suitably performs input or selection using a predetermined input dialog presented on the display part 14 by the action of the placement condition information setting part 31, thereby setting the placement condition information IC including the contents shown in FIG. 13.

The table TBL3 contains an item T11 indicating an identification number ID (head ID), an item T12 indicating the rage of pages into which the logo object LG1 is to be placed as a head, an item T13 indicating a meta title of a page in which the logo object LG1 is to be placed, an item T14 indicating a position on a page to which the logo object LB1 is to be located, and an item T15 indicating information for specifying image data of the logo object LG1 to be placed. Namely, the content in the item T12 forms placement page information I1 of the placement condition information IC, the content in the item T14 forms location information I2 of the placement condition information IC, and the contents in the items T13 and T15 form object information I3 of the placement condition information IC.

The table TBL3 contains information only about an object assigned an identification number ID “1”. In the item T15, image data titled “DOGLOGO” is shown to be a target of placement, which data is precisely a file of the TIFF format titled “DOGLOGO.tif”.

A “meta title” as the content of the item T13 is a keyword indicating the description of each page text. The necessity of placement of an object is determined in the second preferred embodiment based on the description of page text as discussed, making reference to a meta title described in target page data DP0'. A meta title is a keyword directly indicative of the content of each of the pages represented by the target page data DP0'. It will be discussed later how such a meta title is described in page data.

<Object Placement>

Next, it will be discussed how the object incorporating processor 40 is operative to place a “head” into the target page data DP0', namely, how the logo object LG1 is incorporated.

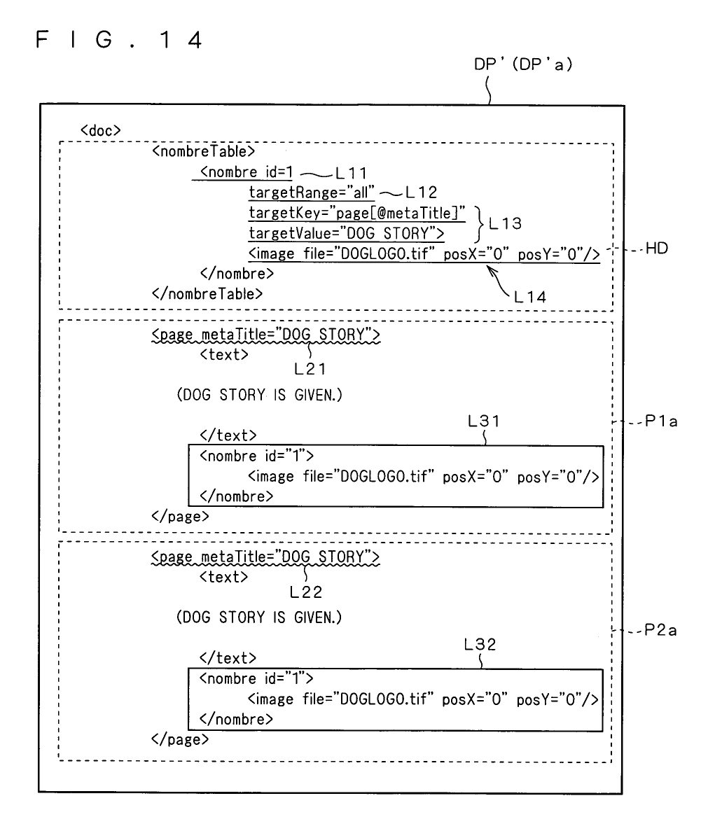

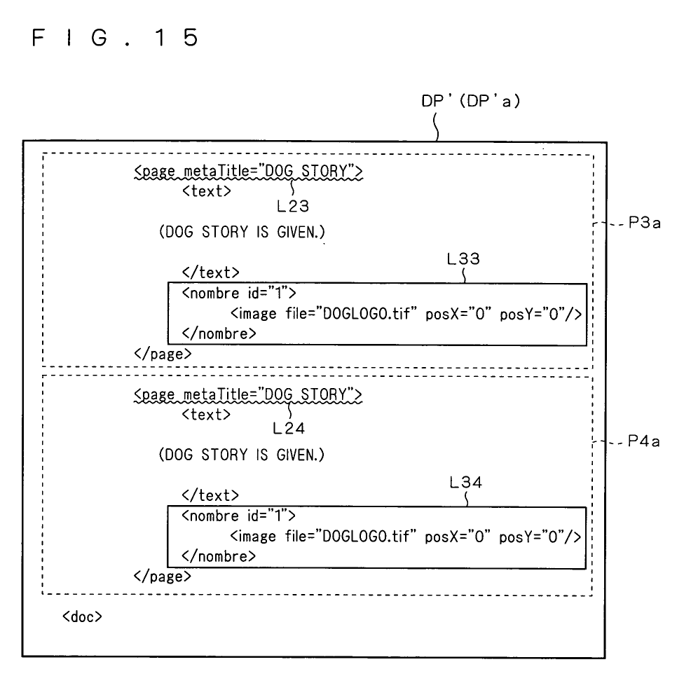

FIGS. 14 and 15 are views each showing part of the contents of the page data DP′ a described in a PDL. In the page data DP′a, <page> tags define corresponding pages. FIG. 14 shows page descriptions P1a and P2a respectively representing pages 1 and 2. FIG. 14 also shows header information HD preceding substantial page descriptions from P1a onward. The header information HD contains the placement condition information IC described with a <nombreTable> tag. That is, the contents of the header information HD indicate those incorporated into the target page data DP0' by the action of the object incorporating processor 40. FIG. 15 shows page descriptions P3a and P4a respectively representing pages 3 and 4.

A <nombre> tag between <nombreTable> and </nombreTable> tags contains an ‘id’ attribute that corresponds to the identification number ID, whereby in the header information HD, the description representing the contents of the placement condition information IC is given for each object. Statement L11 contains description ‘id=1’ as an ‘id’ attribute, meaning that this <nombre> tag contains the description related to the placement condition information IC assigned the identification number ID “1”. As for this <nombre> tag, represented as statement L12 and statement L13, descriptions for specifying page range and meta title of a page as a target of object incorporation are also given by predetermined attributes, respectively. Here, ‘targetRange=“all”’ is specified as a ‘targetRange’ attribute, indicating that the page range as a target of object placement covers all pages. Further, ‘targetKey=page[@metaTitle]’ and ‘targetValue=Dog Story’ are specified as ‘targetKey’ and ‘TargetValue’ attributes, respectively, showing the conditions of a meta title of a target page of object placement. More specifically, these descriptions indicate that an object is to be incorporated into a page with a meta title “dog story”. Represented as statement L14, an <image> tag is employed for specifying the file name or location of a logo object (image data) to be placed with predetermined attributes.

In each of the page descriptions P1a through P4a, a <text> tag is employed for description of page text. It is assumed a certain topic related to dogs (hereinafter referred to as a “dog story”) is described. Although not shown, such a tag that realizes the placement of an image and the like may be employed in the descriptions P1a through P4a.

In a <page> tag in each page description, ‘metaTitle=“dog story”’ is given as a ‘metaTitle’ attribute showing a meta title provided to each page. As seen from FIGS. 14 and 15, pages 1 through 4 in the page data DP′a are each provided with a meta title “dog story”. As an exemplary way to describe a meta title in page data, in layout data editing on the side of the client computer C, an operator may give some phrase (here, “dog story”) through a certain input dialog that is to be used as a meta title of each page. Preferably, such a phrase is suitably representative of the description of each page text. Alternatively, a caption may be automatically extracted from the description of page text for use as a meta title.

In object placement of the second preferred embodiment, the contents of the placement condition information IC are described first with a <nombre> tag between <nombreTable> and </nombreTable> tags. Next, sequentially making reference to ‘metaTitle’ attributes given in respective <page> tags in the page descriptions, an object is placed at a specified position on a page in which conditions for a meta title described with a <nombre> tag in the header information HD are satisfied by a ‘metaTitle’ attribute in a <page> tag.

Then only a page falling within the range specified in the item T12 in the table TBL3 and assigned a meta title which coincides with the meta title specified in the item T13 is subjected to addition of the logo object LG1 in the form of image data specified in the item T15. As a result, the page data DP′a is obtained.

As seen from statements L21, L22, L23 and L24 in the page data DP′a shown in FIGS. 14 and 15, each page is assigned ‘metaTitle=“dog story”’ as a ‘metaTitle’ attribute in a <page> tag. This attribute is described in advance in the target page data DP0' before subjected to object placement.

Here, the contents of the placement condition information IC assigned the identification number “1” are satisfied with respect to each page. Then description to realize the placement of the image data “DOGLOGO.tif” at a prescribed position is given in a certain format in the portion defined between <page> and </page> tags on each page description. More specifically, represented as statements L31, L32, L33 and L34, descriptions specifying identification number ID as an ‘id’ attribute by employing a <nombre> tag and specifying image data to be placed and its position by employing an <image> tag are incorporated in each page description. Then the page data DP′a is created to obtain the image of a printed matter shown in FIG. 12.

This means that object placement that an object is associated with the description of page text is implemented. As discussed above, the page text on each page contains a “dog story” and thus, object placement is in conformity with the description of the page text. To realize such object placement, the data file “DOGLOGO.tif” should be stored in advance in a certain storage such as the storage part 12 in the form of readable data.

<Object Renewal>

Next, it will be discussed how the description of page text is changed on a page by page basis in the page data DP′a into which the logo object LG1 is placed. As an example, certain page data DP′ is extracted from certain job data DJ and the contents of the extracted page data DP′ are thereafter changed for example by the client computer C, thereby creating new page data or even new job data.

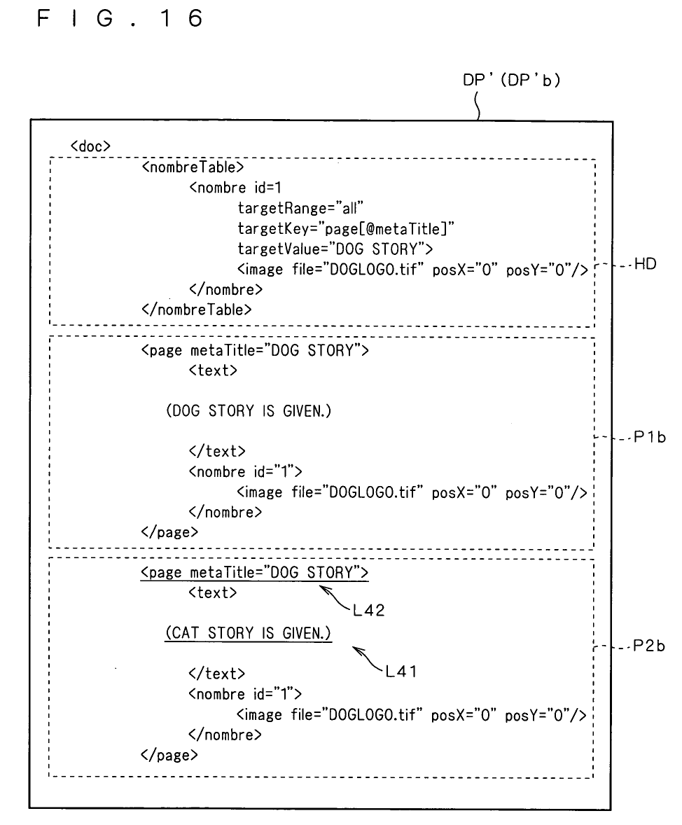

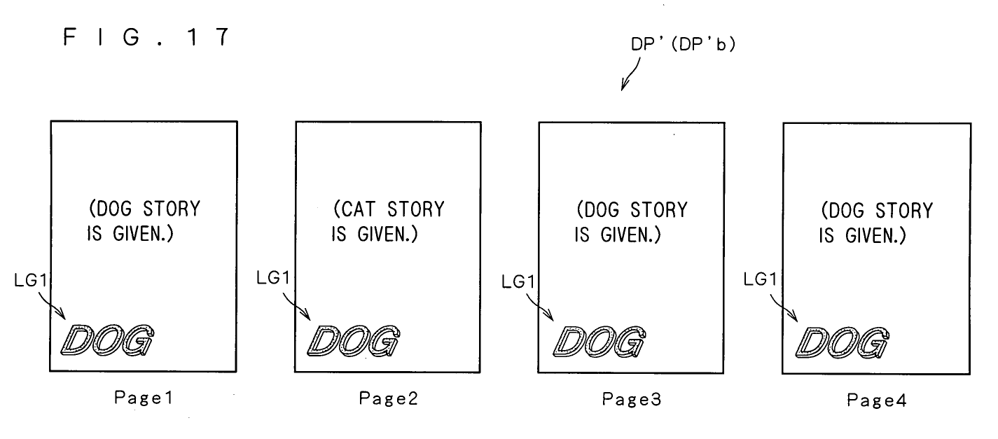

FIG. 16 is a view showing part of page data DP′b reflecting some change made to the description of the page data DP′a. More specifically, as seen from statement L41 in page description P2b, a topic of the description of the text on page 2 (the description given with a <text> tag) is changed from a “dog story” to the one related to cats (hereinafter referred to as a “cat story”). FIG. 17 shows the image of a printed matter represented by the page data DP′b including such change. As seen from statement L42, the meta title of page 2 is not changed. Thus, in the image on page 2 as one of those shown in FIG. 17, the logo object LG1 realized by the image data “DOGLOGO.tif” still remains although a “cat story” is given in the page text on page 2. As the logo object LG1 is intended to facilitate understanding of page description, and hence, such situation is deemed to be undesirable.

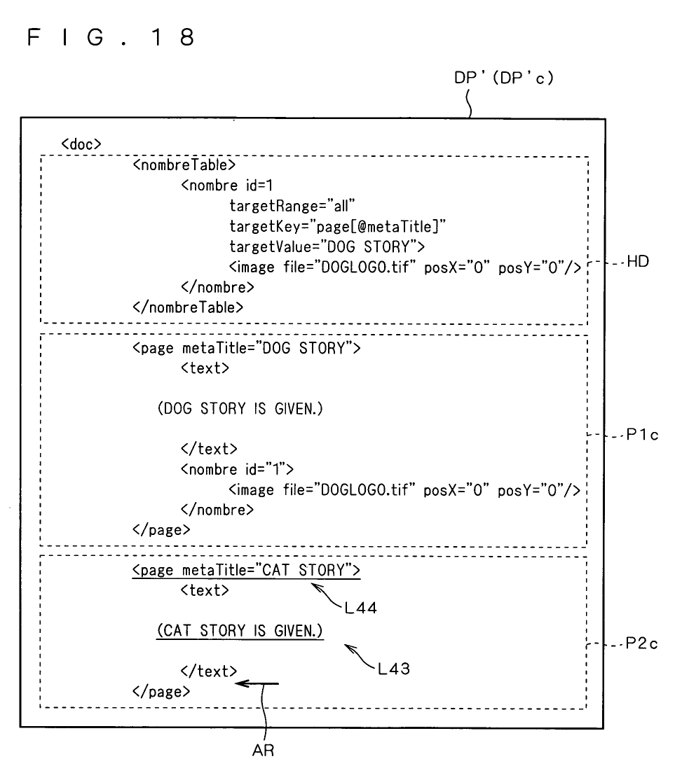

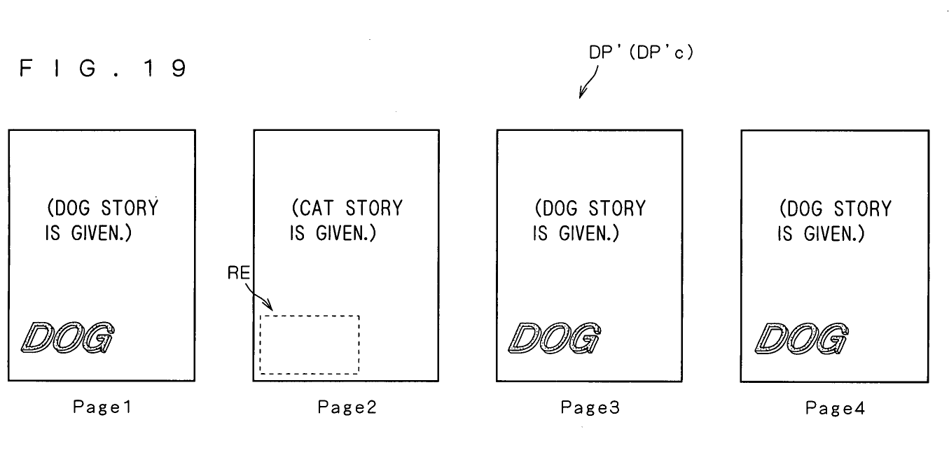

FIG. 18 is a view showing part of page data DP′c reflecting some change made to the description of the page data DP′a. FIG. 19 shows the image of a printed matter represented by the page data DP′c including such change. The page data DP′c contains header information HD and page description P1c which respectively coincide with the header information HD and page description P1a in the page data DP′a shown in FIG. 14, and with the header information HD and page description P1b in the page data DP′b shown in FIG. 16. However, as seen from statement L43 in page description P2c, a “cat story” is given in the text on page 2. In addition, the meta title of page 2 is changed to “cat story” as indicated by statement L44. That is, a meta title in conformity with the description of page text is given. As an exemplary way to change a meta title while changing the description of page text, a predetermined input dialog is presented on the display part 14 while changing process of page text, and an operator inputs a new meta title using this input dialog.

In this case, in the image of a printed matter shown in FIG. 19, no object is placed in a region RE on page 2 in which the logo object LG1 has originally been located. This is because the placement condition information IC related to the page data DP′c specifies that only a page provided with a meta title “dog story” is to be subjected to object placement, whereas page 2 is provided with a meta title “cat story”. The meta title as given does not satisfy the condition for a meta title specified in the placement condition information. Thus, the description related to the placement of the logo object LG1 realized by “DOGLOGO.tif” originally included in the page data DP′a is eliminated from the page data DP′c (see arrow AR in FIG. 18).

As discussed, by changing the meta title of a page to conform to the change of the description of the same page, an undesirable situation is prevented in which an object which is not in conformity with the description of text remains as a logo in a printed matter, for example. It is not required to manually check up on the suitability of object placement, and to remove each unnecessary object if present. Thus object placement can be realized with a high degree of efficiency and reliability.

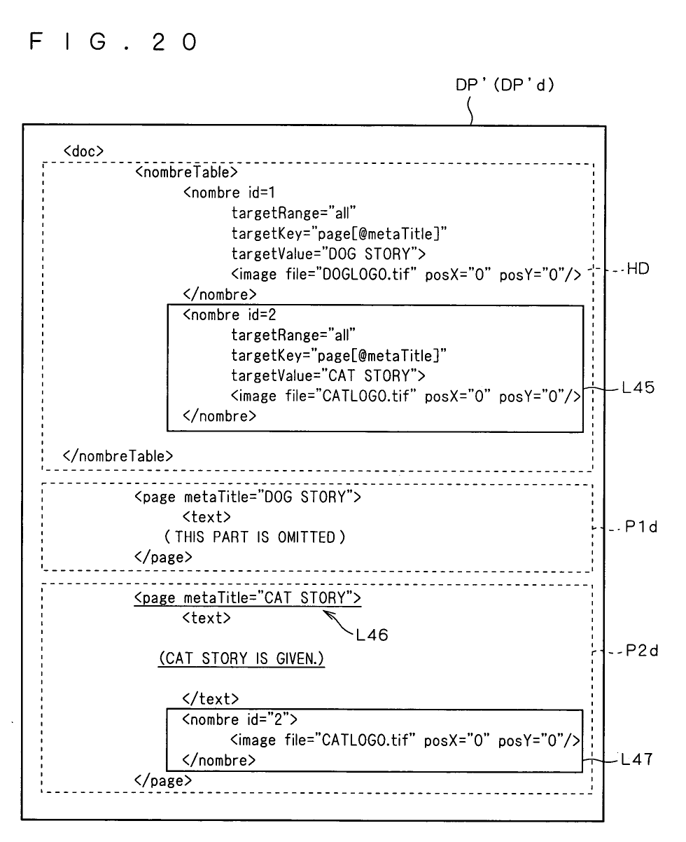

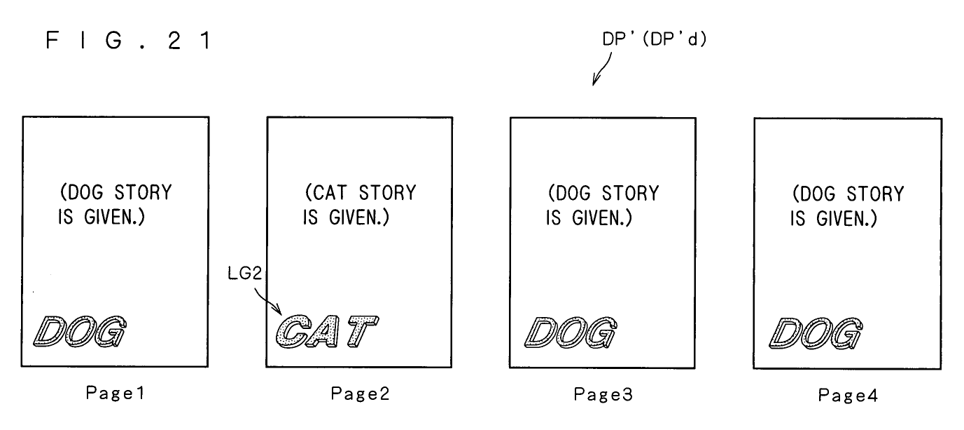

In the example given above, placement condition information IC about a different object may be suitably prepared so that a page describing a “cat story” can also be provided with an object that is suitably indicative of the description of this page. FIG. 20 is a view showing part of page data DP′d in responsive to such placement reflecting some change made to the description of the page data DP′a. FIG. 21 shows the image of a printed matter represented by the page data DP′d. While there is no change in page description P1d and page descriptions of page 3 onward not shown, placement condition information which contains ‘id=2’ as an ‘id’ attribute represented as statement L45, namely, assigned the identification number “2” is newly incorporated into the header information HD. According to this placement condition information, when a meta title is a “cat story”, a logo object given by data “CATLOGO.tif” is placed. A “cat story” is given as the meta title of page 2 as seen from statement L46 in page description P2d. Thus, in creation of the page data DP′d, a logo object given by the data “CATLOGO.tif” is placed on page 2 as expressed in statement L47. FIG. 21 shows the image of a printed matter reflecting such placement. As seen from FIG. 21, only page 2 contains a logo object LG2 that does not appear on other pages. In this case, the logo objects of FIG. 21 more suitably indicate the contents of a printed matter than those shown in FIG. 19. To realize such object placement, the data file “CATLOGO.tif” should be stored in advance in a certain storage such as the storage part 12 in the form of readable data.

In the case of creation of new page data, different from making such placement change, an object suitably indicative of a page is certainly placed in response to a meta title set for each page if several pieces of placement condition information are prepared in advance.

As given in the foregoing description of the second preferred embodiment, for addition of an object to page data, conditions required for the placement of this object onto each page are defined in association with a meta title indicative of the description of page text. An object failing to reflect the change of the description of page text is prevented from remaining without manually checking up on the existence thereof. Thus object placement can be realized with a high degree of efficiency and reliability.

### Modifications of Second Preferred Embodiment

In the second preferred embodiment described above, job data contains one piece of page data, and a page printing as a printed matter is produced based on this page data. Alternatively, page data representing one page of a printed matter may be stored as an independent file in job data Files each containing page data may be subjected to output operation in a predetermined order to produce a printed matter. In this alternative, a meta title indicative of each data file described in advance therein may be applied to judge the necessity of placement to produce the same effects as those obtained in the second preferred embodiment. In this case, information identifying a data file to be subjected to object placement is given as the location information I2.

While the invention has been shown and described in detail, the foregoing description is in all aspects illustrative and not restrictive. It is therefore understood that numerous modifications and variations can be devised without departing from the scope of the invention.

1. A printing data processor for processing page data described in a predetermined page description language, comprising:
a placement condition information setting element for setting placement condition information applied for placement of a page element into a printed matter, said placement condition information being in one-to-one correspondence to at least one form of object representing said page element; and
a page data creation element for incorporating said at least one form of object into first page data based on said placement condition information to create second page data, said second page data representing a printed matter in which said page element is placed,
wherein said placement condition information setting element is capable of defining setting for incorporating said at least one form of object into each page of said first page data as said placement condition information, and
wherein said setting can be associated with the contents of said each page.

2. The printing data processor according to claim 1,
wherein when several forms of objects are incorporated to create said second page data, said placement condition information setting element is capable of setting placement condition information for incorporating one form of said several forms of objects into said each page in association with placement condition information on another form of said several forms of objects.

3. The printing data processor according to claim 2,
wherein the placement condition information on said another form of said several forms of objects indicates the presence or absence of incorporation of said different form into each page.

4. The printing data processor according to claim 2,
wherein the placement condition information on said different form of said several forms of objects includes the format of said another form on each page.

5. The printing data processor according to claim 1,
wherein said placement condition information setting element is capable of defining setting for incorporating said at least one form of object into each page of said first page data as said placement condition information, and
wherein said setting can be associated with the description of text of said each page.

6. The printing data processor according to claim 1,
wherein said page data creation element comprises:
a temporary data creation element for creating temporary data, said temporary data visibly presenting a condition on a predetermined display element in which said page element is placed into a printed matter represented by said first page data;
a page data conversion element for converting said temporary data to said second page data described in said page description language; and
a renewal instruction processing element for causing said temporary data creation element to create said temporary data in response to certain renewal timing information.

7. The printing data processor according to claim 1, further comprising:
a control element for controlling a certain printer in output operation based on said second page data.

8. A printing system, comprising:
a) a printer for executing printing based on certain page data; and
b) a printing data processor for processing page data described in a predetermined page description language, comprising:
b-1) a placement condition information setting element for setting placement condition information applied for placement of a page element into a printed matter, said placement condition information being in one-to-one correspondence to at least one form of object representing said page element;
b-2) a page data creation element for incorporating said at least one form of object into first page data based on said placement condition information to create second page data, said second page data representing a printed matter in which said page element is placed; and
b-3) a control element for controlling said printer in output operation based on said second page data,
wherein said placement condition information setting element is capable of defining setting for incorporating said at least one form of object into each page of said first page data as said placement condition information, and
wherein said setting can be associated with the contents of said each page.

9. The printing system according to claim 8,
wherein when several forms of objects are incorporated to create said second page data, said placement condition information setting element is capable of setting placement condition information for incorporating one form of said several forms of objects into said each page in association with placement condition information on another form of said several forms of objects.

10. The printing system according to claim 8,
wherein said placement condition information setting element is capable of defining setting for incorporating said at least one form of object into each page of said first page data as said placement condition information, and
wherein said setting can be associated with the description of text of said each page.

11. A method of incorporating an object into page data described in a predetermined page description language, said object representing a certain page element, said method comprising the steps of:
a) setting placement condition information applied for placement of a page element into a printed matter, said placement condition information being in one-to-one correspondence to at least one form of object representing said page element; and
b) incorporating said at least one form of object into first page data based on said placement condition information to create second page data,
wherein in said step a), setting for incorporating said at least one form of object into each page of said first data is defined as said placement condition information, and
wherein said setting is associated with the contents of said each page.

12. The method according to claim 11,
wherein when several forms of objects are incorporated create said second page data in said step b), placement condition information for incorporating one form of said several forms of objects into said each page is set in association with placement condition information on another form of said several forms of objects in said step a).

13. The method according to claim 12,
wherein the placement condition information on said different form of said several forms of objects indicates the presence or absence of incorporation of said another form into each page.

14. The method according to claim 12,
wherein the placement condition information on said another form of said several forms of objects includes the format of said another form on each page.

15. The method according to claim 11,
wherein in said step a), setting for incorporating said at least one form of object into each page of said first data is defined as said placement condition information, and
wherein said setting is associated with the description of text of said each page.

16. The method according to claim 11,
wherein said step b) comprises the steps of:
b-1) creating temporary data, said temporary data visibly presenting a condition on a predetermined display element in which said page element is placed into a printed matter represented by said first page data;
b-2) converting said temporary data to said second page data described in said page description language; and
b-3) urging creation of said temporary data in response to certain renewal timing information.

17. A program, when executed by a computer, for causing said computer to function as a printing data processor for processing page data described in a predetermined page description language, said printing data processor comprising:
a placement condition information setting element for setting placement condition information applied for placement of a page element into a printed matter, said placement condition information being in one-to-one correspondence to at least one form of object representing said page element; and
a page data creation element for incorporating said at least one form of object into first page data based on said placement condition information to create second page data, said second page data representing a printed matter in which said page element is placed,
wherein said placement condition information setting element is capable of defining setting for incorporating said at least one form of object into each page of said first page data as said placement condition information, and
wherein said setting can be associated with the contents of said each page.
